(19) United States
(12) Patent Application Publication
(10) Pub. No.: US 2009/0328133 A1
(43) Pub. Date: Dec. 31, 2009

(54) CAPABILITY MANAGEMENT FOR NETWORK ELEMENTS

(75) Inventors: John C. Strassner, North Barrington, IL (US); Gregory W. Cox, Schaumburg, IL (US); Zhi Fu, Lake Zurich, IL (US); Yan Liu, Hanover Park, IL (US); David L. Raymer, JR., Watauga, TX (US)

Correspondence Address: FLEIT, GIBBONS, GUTMAN, BONGINI;& BIANCO P.L., 551 N.W. 77TH STREET, SUITE 111, BOCA RATON, FL, 33487, US

(73) Assignee: Motorola, Inc., Schaumburg, IL (US)

(21) Appl. No.: 12/163,343

(22) Filed: Jun. 27, 2008

(51) Int. Cl. H04L 9/00; G06F 15/173

(52) U.S. Cl. 726/1; 709/223

(57) ABSTRACT

A method, information processing system, and system manage network entities. At least a portion of at least one information model (120) for a first managed entity (104) and at least a second managed entity (106) is accessed. The portion of the at least one information model (120) includes a set of capabilities (542) associated with the first managed entity (104) and second managed entity (106), respectively. A first set of capabilities (708) supported by the first managed entity (104) and a second set of capabilities (710) supported by the second managed entity (106) are identified based on the portion of the at least one information model (120). A set of common capabilities (712) from the first set of capabilities (708) and the second set of capabilities (710) that is supported by both of the first managed entity (104) and the second managed entity (106) is determined.

### FIELD OF THE INVENTION

The present invention generally relates to the field of network monitoring and management, and more particularly relates to managing network elements based on capabilities associated therewith.

### BACKGROUND OF THE INVENTION

Networks consist of heterogeneous computing elements, each with their own distinct set of functions and approaches to providing commands and data regarding the operation of those functions. Some functions have direct requirements on associated resources, such as CPU clock speed, amount of memory, type of media, media bandwidth, and other factors. This complicates determining if a given feature is available for a given contextual task. Furthermore, even the same device from the same vendor can run multiple versions of an operating system, which means that it may have different, incompatible formats for providing data and receiving commands.

Currently, management elements are built in a custom/stovepipe fashion precisely because of the above limitations. This prohibits management systems from sharing and communicating decisions on similar data and commands. Hence, additional software must be built for each combination of management systems that need to communicate. This results in the inability of current management systems to correlate different instances of events and data to understand their common semantics (e.g., a single common cause of multiple problems reported in different ways using different data). For example, it is generally impossible to directly correlate a Service Level Agreement (SLA) violation for a customer or set of customers with an alarm issued by a network device, since the network device has no understanding of “customer” or “SLA”. This dramatically increases the complexity of the overall system.

This is one of the many reasons that have led to the pursuit of policy management (See Strassner, J., “Policy-Based Network Management”, Morgan Kaufman Publishers, September 2003, ISBN 1-55860-859-1, which is hereby incorporated by reference in its entirety). In particular, the ability to hide vendor-specific interfaces behind a uniform interface is very important. Without this ability, a common interface to programming the same function in different network devices generally cannot be accomplished. This is one of the toughest problems a network manager needs to deal with; how to string a network of multi-vendor equipment together, where each equipment in general has a different programming model and management data, to provide a seamless set of customer-facing services. However, if the scenario includes adaptability, then static, pre-defined, policy rules generally cannot deal with the above scenario. For example, if the use of a particular feature among a set of features changes with context, then it becomes very difficult, if not impossible, to write policy rules to govern this case, since the number of policy rules written will increase commensurate with the number of features times the different ways that they can be put together.

The traditional solution of fixed, pre-defined policy rules is difficult to use in cases of varying configurations and contexts, since (1) if there are changes in user needs, environmental conditions, and/or business goals, the static policies may no longer be appropriate to manage them, and worse, a (statically-defined) policy may not have been defined to govern the new functionality that is required by these three types of changes; (2) current state-of-the-art is to write policies at a very low level, usually governing a small number of features; the above use case produces an unmanageable and inflexible explosion of policy rules written to directly handle various system configurations and context; and (3) different service and function subsets can interact in many different ways, which complicates the design and implementation of traditional policies.

Therefore a need exists to overcome the problems with the prior art as discussed above.

### SUMMARY OF THE INVENTION

In one embodiment, a method for managing entities is disclosed. The method includes accessing at least a portion of at least one information model for a first managed entity and at least a second managed entity. The portion of the at least one information model includes a set of capabilities associated with the first managed entity and the at least second managed entity, respectively. A capability is at least one of i) a feature; ii) a resource; or iii) a service associated with a managed entity and is externally visible by a given entity for external monitoring by the given entity. The portion of at least one information model represents at least one of characteristics and static behavior of each capability in the set of capabilities. A first set of capabilities supported by the first managed entity and a second set of capabilities supported by the at least second managed entity are identified based on the portion of the at least one information model. A set of common capabilities from the first set of capabilities and the second set of capabilities that is supported by both of the first managed entity and the at least second managed entity is determined in response to identifying the first set of capabilities and the second set of capabilities.

These capabilities determine the common functionality (or lack thereof) that are shared between the first managed entity and the at least second managed entity, and hence also determine their interoperability. They can also be used as the basis for negotiating which features should be used for a given application.

In another embodiment, an information processing system for managing entities is disclosed. The information processing system includes a memory and a processor communicatively coupled to the memory. A network element manager is communicatively coupled to the memory and the processor. The network element manager is adapted to access at least a portion of at least one information model for a first managed entity and at least a second managed entity. The portion of the at least one information model includes a set of capabilities associated with the first managed entity and the at least second managed entity, respectively. A capability is at least one of i) a feature; ii) a resource; or iii) a service associated with a managed entity and is externally visible by a given entity for external monitoring by the given entity. The portion of at least one information model represents at least one of characteristics and static behavior of each capability in the set of capabilities. A first set of capabilities supported by the first managed entity and a second set of capabilities supported by the at least second managed entity are identified based on the portion of the at least one information model. A set of common capabilities from the first set of capabilities and the second set of capabilities that is supported by both of the first managed entity and the at least second managed entity is determined in response to identifying the first set of capabilities and the second set of capabilities.

In yet another embodiment, a system for managing entities is disclosed. The system includes at least one network and at least a first managed entity communicatively coupled to the network. At least a second managed entity is communicatively coupled to the network. At least one information processing system is communicatively coupled to the network and the first managed entity and the at least second managed entity. The information processing system includes a memory and a processor communicatively coupled to the memory. A network element manager is communicatively coupled to the memory and the processor. The network element manager is adapted to access at least a portion of at least one information model for a first managed entity and at least a second managed entity. The portion of the at least one information model includes a set of capabilities associated with the first managed entity and the at least second managed entity, respectively. A capability is at least one of i) a feature; ii) a resource; or iii) a service associated with a managed entity and is externally visible by a given entity for external monitoring by the given entity. The portion of at least one information model represents at least one of characteristics and static behavior of each capability in the set of capabilities. A first set of capabilities supported by the first managed entity and a second set of capabilities supported by the at least second managed entity are identified based on the portion of the at least one information model. A set of common capabilities from the first set of capabilities and the second set of capabilities that is supported by both of the first managed entity and the at least second managed entity is determined in response to identifying the first set of capabilities and the second set of capabilities.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a general overview of an operating environment according to one embodiment of the present invention;

FIG. 2 is simple capability communication flow between two managed entities according to one embodiment of the present invention;

FIG. 3 is a simplified Unified Modeling Language capability model according to one embodiment of the present invention;

FIG. 4 is a diagram illustrating how ontological data augments model data according to one embodiment of the present invention;

FIG. 5 is a simplified Unified Modeling Language context-aware capability model according to one embodiment of the present invention;

FIG. 6 is a policy based capability graph according to one embodiment of the present invention;

FIG. 7 is an operational flow diagram illustrating one process of managing network elements using capabilities of those elements according to one embodiment of the present invention;

FIG. 8 is an operational flow diagram illustrating one process of constructing capabilities according to one embodiment of the present invention; and

FIG. 9 is a block diagram illustrating a detailed view of an information processing system, according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

General Operating Environment

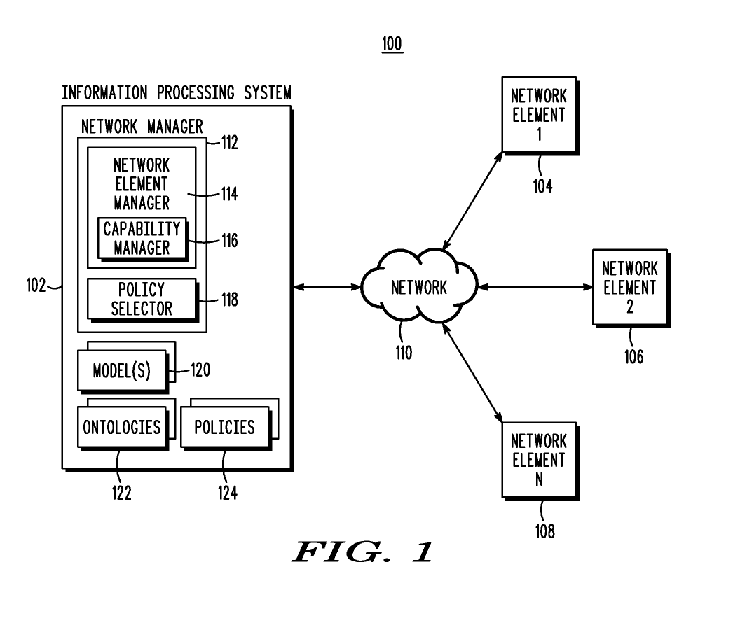

According to one embodiment of the present invention as shown in FIG. 1 a general overview of an operating environment 100 is illustrated. In particular, the operating environment 100 includes one or more information processing systems 102 communicatively coupled to one or more network elements 104, 106, 108. A network element, in one embodiment, can be (but not limited to) routers, switches, hubs, gateways, base stations, and wireless communication devices. The information processing system 102 is communicatively coupled to each of the network elements 104, 106, 108 via one or more networks 110, which can comprise wired and/or wireless technologies.

The information processing system 102, in one embodiment, includes a network manager 112, which comprises a network element manager 114, a capability manager 116, and a policy selector 118. The information processing system 102 also includes various models 120 such as information and data models, ontologies 122, and policies 124. It should be noted that one or more components of the information processing system 102 shown in FIG. 1 can reside on other systems as well. For example, the models 120, ontolgoies 122, and/or policies 124 can reside on one or more systems that are communicatively coupled to the information processing system 102. Each component of the information processing system 102 is discussed in greater detail below.

Capabilities

Each of the network elements 104, 106, 108 is associated with various functions and/or services. Many different combinations of such functions and services can be used to achieve a given capability. In one embodiment, an entity can be a system, network, device, component, or other unit of abstraction. Capabilities are features, resources, or services that are externally visible and can be monitored and/or controlled. In one embodiment, capabilities are associated with context as well as policies, as will be discussed in greater detail below, enabling capabilities to reflect different functionality offered by context-aware systems when the context changes. The network manager element manager 114, in one embodiment, manages the capabilities of elements 104, 106, 108 via the capability manager 116.

Conceptually, capabilities are the salient functions of a component, device, network, or system that are externally visible. This enables capabilities to be externally monitored and/or controlled (programmed). Capabilities may define the actual feature, or be the end result of an invoked feature. The entity using the capability does not care whether the capability defines an actual feature or is an end result of an invoked feature, since capabilities are used to abstract the feature(s) that they represent.

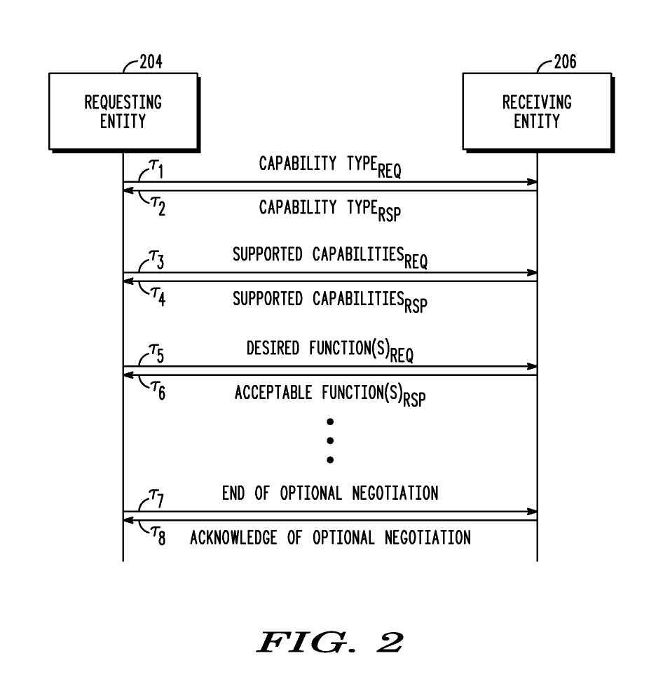

Capabilities are intended to increase the interoperability between and simplify the programming of managed entities in the system. For example, FIG. 2 shows a simplified capability communication flow between two managed entities 204, 206. The requesting entity 204, at time T1, first establishes how capabilities are to be represented (e.g., functional, imperative, or declarative) by sending a CapabilityType request to a receiving entity 206. The receiving entity, at time T2, sends a CapabilityType response back the requesting entity 204.

The CapabilityType response indicates how the capabilities are to be represented. The requesting entity 204, at time T3, then sends a Supported Capabilities request to the receiving entity 206. Supported capabilities are the capabilities that the requesting entity 204 knows about and can either measure or control. The receiving entity 206, at time T4, sends a Supported Capabilities response back to the requesting entity 204 that indicates the set of capabilities requested by entity 204 that are supported by the receiving entity 206.

The requesting entity 204, at time T5, sends a Desired Function(s) request to the receiving entity 206 that indicates what functions the requesting entity 204 wants to have performed or available. Each capability may correspond to one or more Desired Functions. A set of optional negotiations then ensues that defines which capabilities may be used. For example, the receiving entity 206, at time T6, sends an Acceptable Function(s) response to the requesting entity 204 that indicates what functions the requesting entity 206 will accept. One example of a negotiation process applicable to the various embodiments of the present invention is discussed in U.S. patent application Ser. No. 12/132,434, filed on Jun. 3, 2008, entitled, “Method and Apparatus to Facilitate Negotiation of a Selection of Capabilities to Be employed When Facilitating a Task”, with Attorney Docket Number CML06081 MNG, which is hereby incorporated by reference in its entirety. At time T7 the negotiations end and at time T8 the receiving entity 206 acknowledges the optional negotiation.

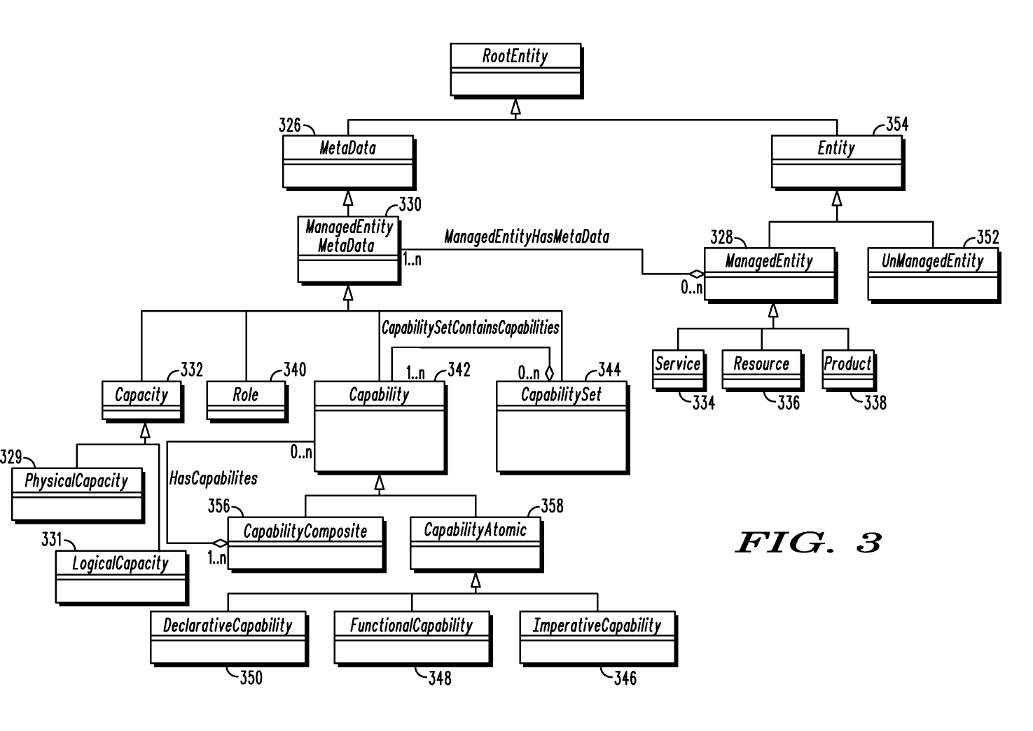

A capability can be a single feature or a set of related features (e.g., encryption at various strengths). More importantly, capabilities can be defined according to a number of popular programming paradigms, including but not limited to imperative, functional, and declarative programming styles. This enables a model of capabilities such as the simplified Unified Modeling Language (“UML”) capability model shown in FIG. 3 to be used in a more efficient manner by different programming languages. This is because capabilities can be expressed according to a number of different styles used by different programming languages.

For example, representing a Virtual Private Network (“VPN”) can be done imperatively by specifying procedures that manipulate the state of objects to create a VPN; functionally by applying functions that create the VPN to the appropriate objects; declaratively by defining the goal of creating a VPN without defining the precise steps to implement that goal. Similarly, imperative, functional, or declarative capabilities can be used as an interface to apply model-driven techniques (See [www.omg.org/mda], which is hereby incorporated by reference in its entirety) to a model to generate the code required to implement the VPN directly from the model and the appropriate capabilities.

Capabilities, in one embodiment, are defined by the capability manager 116 using a combination of an information model 120 (and optionally, one or more data models to define a capability's implementation) to represent basic characteristics and static behavior of the capability, augmented with one or more ontologies 122 to represent related concepts and additional behavior of the capability. An information model 120 is more than “just” a representation of a set of objects. The most important feature of an information model 120 is its ability to describe relationships between managed objects. From this, other types of models and diagrams, such as defining how data flows within the system, can be defined.

Capabilities are first defined by annotating selected model objects and/or ontology concepts with appropriate metadata. The DEN-ng information model is unique, in that it defines the notion of capabilities in an extensible manner using a pattern, enabling all managed entities to optionally have capabilities attached to them. (Note that DEN-ng also defines unmanaged entities 352 (FIG. 3), but since they are unmanageable, no capabilities can be associated with them).

FIG. 3 defines metadata information (which is represented as instances of the class MetaData 326) to describe data and concepts that do not contribute to or impact the state of an entity. FIG. 3 shows a RootEntity class 323, which is is the most abstract entity in the model. The RootEntity class 323 includes only those characteristics that are common to all of the classes in the model. All other classes in a model are directly or indirectly subclassed from the root entity. In other words, the root entity is the top of the DEN-ng class hierarchy. The RootEntity class 323 properties enables naming, description, and identification of all objects (manageable and unmanageable) in the environment.

The following is a general overview of the most important types of metadata that are currently defined in DEN-ng that are relevant to the concept of capabilities. It should be noted that additional types of metadata as well as corresponding capabilities can be easily defined as needed, because DEN-ng is based on using patterns, roles, and classification theory, which make it inherently extensible. Patterns simplify the conceptualization and implementation of an entity; roles are a powerful abstraction mechanism that ensure that the role being played, as opposed to the entity itself, is modeled (thus simplifying the design of both and ensuring that entities are not cluttered with application-specific data); classification theory has been used throughout DEN-ng to organize objects into groups according to their similarities and differences or their relation to a set of criteria. Note also that since the class ManagedEntity 328 (which is a subclass of Entity 354) can have metadata attached to them (as indicated by the ManagedEntityHasMetaData aggregation between the ManagedEntity class 328 and the ManagedEntityMetadata class 330), they can also have Capabilities. Other types of entities can have Capabilities, but this level of detail makes the above figure much more complex, and has been suppressed.

The ManagedEntityMetaData class 330 includes data for different types of ManagedEntities (e.g., Services 334, Resources 336, and Products 338) that describes, but does not contribute to or impact, the state of the ManagedEntity 328. The Capacity class 332 is an abstract class that is the parent for both the PhysicalCapacity 329 as well as the LogicalCapacity 331 classes. They are used to define the minimum and maximum requirements, limits, or other variable features of a ManagedEntity 328. Capacity 332 is a reflection of state, and may be used to help define when a ManagedEntity 328 transitions state.

The Role class 340 is an abstract class that defines the concept of various types of roles used in the DEN-ng model. Each role uses the role-object pattern (or variants thereof) to define an extensible representation of the concept that it is being modeled. The role-object pattern is discussed in greater detail in Baumer, D. Riehle, W. Siberski, M. Wulf, “The Role Object Pattern”, [(st-www.cs.uiuc.edu/˜hanmer/PLoP-97/Proceedings/riehle.pdf)], which is hereby incorporated by reference in its entirety. The Capability class 342 is an abstract class that represents one or more features, resources, or services that are externally visible and can be monitored and/or controlled. The composite pattern, as used for example in the combination of the Capability class 342, the CapabilityComposite class 356, and the CapabilityAtomic class 358, is used to model hierarchies of capabilities. A more detailed discussion of the composite pattern can be found at [(http://www.exciton.cs.rice.edu/javaresources/DesignPatterns/composite.htm)], which is hereby incorporated by reference in its entirety.

Briefly, this works as follows. Both the CapabilityComposite class 356 and the CapabilityAtomic class 358 are subclasses of the Capability class 342; hence, each is types of the Capability class. The CapabilityAtomic class 358 represents stand-alone capabilities, while the CapabilityComposite class 356 represents groups of Capabilities. Note that the aggregation HasCapabilities enables the CapabilityComposite class 356 to contain instances of CapabilityAtomic classes 358 and CapabilityComposite classes 356, since both the CapabilityAtomic class 358 and the CapabilityComposite class 356 are types of Capabilities. The CapabilitySet class 344 is an abstract class that is used to group different types of Capabilities 342 (as indicated by the CapabilitySetContainsCapabilities aggregation between the Capabilities class 342 and the CapabilitySet class 344), so that the group of Capabilities in the CapabilitySet class 344 are all treated as an atomic unit. This is important for policy conflict detection purposes. For example, in FIG. 3, MetaData contains an attribute priority, which is used to resolve conflicts. Assuming that highest priority takes precedence, then if the priority of a CapabilitySet is greater than the priority of another Capability, all of the Capabilities in that CapabilitySet will be treated before the Capability that is not in the CapabilitySet.

There are different representations of capabilities, each corresponding to one of three programming paradigms. Hence, a given capability can have equivalent representations. Capabilities are organized along the lines of programming paradigms to better introduce how capabilities can be used. This is shown in FIG. 3. An ImperativeCapability 346 is a capability that, when invoked, changes the state of the ManagedEntity 328 that it is attached to ImperativeCapabilities 346 are used to focus on controlling the state of the ManagedEntity 328, as opposed to (for example) focusing on manipulating attributes or relationships of that ManagedEntity 328. This taxonomy is inspired by imperative programs, which are sequences of commands for the computer to perform.

A FunctionalCapability 348 is a capability that, when invoked, causes a particular function or set of functions to execute. A FunctionalCapability 348 does not specify state. This taxonomy is inspired by functional programs, in which computation is carried out entirely through the evaluation of expressions. A DeclarativeCapability 350 is a capability that, when invoked, manipulates attributes and relationships that the ManagedEntity 328 has to achieve a desired purpose. In other words, rather than changing the value of an attribute directly, a DeclarativeCapability 350 defines what is desired, and leaves it up to the ManagedEntity 328 to achieve that goal. This is useful when changes cannot be made through direct manipulation of an attribute or relationship, but rather involve multiple objects. This taxonomy is inspired by declarative programs, which define the goal that the program is to achieve, but not how the program achieves the goal.

As discussed above, ontologies 122 can be used to augment metadata associated with capabilities to represent related concepts and additional behavior of the capability. An ontology 122 is a more advanced concept than an information model While there are many definitions of ontologies, the following definition (from “Handbook of Network and System Administration”, Elsevier (2007), Chapter “Knowledge Engineering Using Ontologies”, Strassner, J., which is hereby incorporated by reference in its entirety) of an ontology will be used.

An ontology is a formal, explicit specification of a shared, machine-readable vocabulary and meanings, in the form of various entities and relationships between them, to describe knowledge about the contents of one or more related subject domains throughout the life cycle of its existence. These entities and relationships are used to represent knowledge in the set of related subject domains. Formal refers to the fact that the ontology should be representable in a formal grammar. Explicit means that the entities and relationships used, and the constraints on their use, are precisely and unambiguously defined in a declarative language suitable for knowledge representation. Shared means that all users of an ontology will represent a concept using the same or equivalent set of entities and relationships. Subject domain refers to the content of the universe of discourse being represented by the ontology.

In one embodiment, data defined by information models 120 (and optionally, data models) as facts. Ontologies 122 are used to both augment the data supplied by the model(s) as well as reason about the facts (e.g., which set of capabilities are optimal? Which set of capabilities are required? Which set of capabilities add no value?). In addition, the choice of how to express a capability is driven by application-specific needs and programming language employed. The combination of models 120 and ontologies 122 also enables the network manager 112 to discover capabilities that were not originally identified as being useful to the solution. This can be used to dynamically adjust the knowledge bases used by the management system 112, so that future similar queries will automatically include this knowledge.

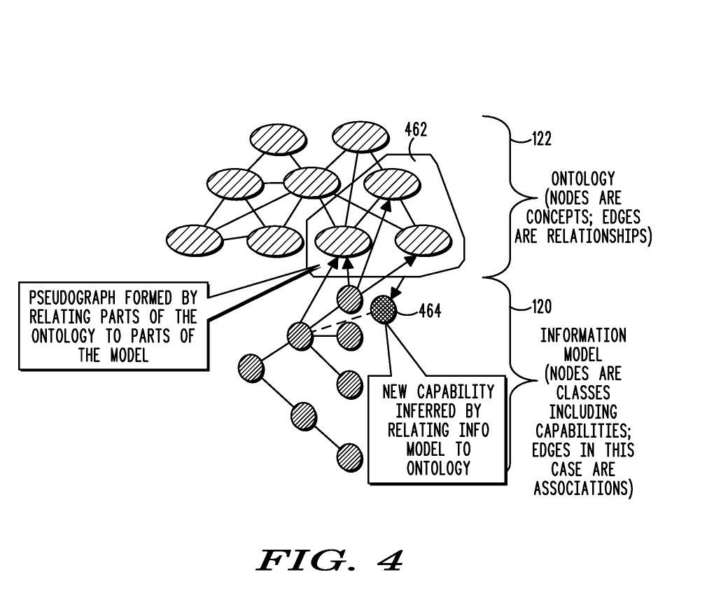

A capability, in general, is modeled as an attribute of a class in a model 120 and “slots” of “concepts” in an ontology 122. Hence, FIG. 4 shows that capabilities, suitably represented in an information and/or data model 120, may be related to knowledge in an ontology 122, by representing each as graphs. The model and ontology graphs may be combined by defining semantic relationships that connect them, forming a new complex graph. Therefore, any appropriate graph algorithm can be used by the network manager 112 to search the resulting graph for capabilities, regardless of whether the capability is in the “information model portion” and/or the “ontology” portion.

Significantly, FIG. 4 implies that capabilities not defined in the information model can be discovered by augmenting appropriate nodes in the information model with ontological data and relationships. FIG. 4 shows that a capability in the information model 120 is related to three different ontological concepts, each of which is related to additional ontological concepts. The result is the inference of a new capability (shown by the enclosed area 462) and realized as a new class in the information model 120 (shown by the new node, which is represented as a cross-hatched circle 464). Note that not every new capability has to be added to the information model; however, since the information model 120 is inherently tied to code generation, there are benefits to doing so when appropriate. More importantly, this enables machine learning and reasoning algorithms to be used to infer new capabilities without having to regenerate such inferences, which can be computationally expensive.

In addition to representing a capability in a model 120, a capability can also be created in an ontology 122. Ontological capabilities only show up in the ontology 122; hence, they are only used when the ontology 122 is used to analyze and/or reason about data in the model. A capability may be represented in both the model 120 as well as in one or more ontologies 122. In this case, extra work must be performed to link the capability in the model 120 to the capability in the ontology 122; an example of how to associate modeled data with ontological data was briefly shown in FIG. 4 and described above. Extra fields in the metadata are added for this case to alert processes that use capabilities that are semantically augmented.

Policy Management Using Capabilities

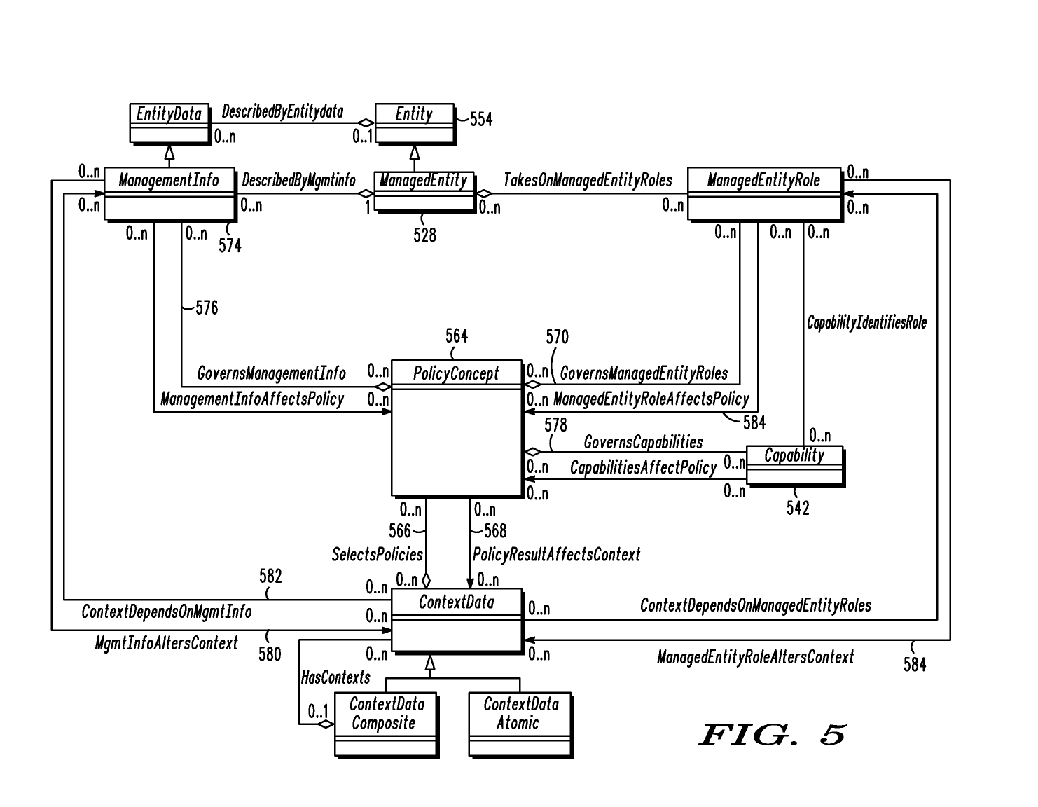

Capabilities can be used to enhance the policy management process. Therefore, various embodiments of the present invention associate capabilities with both context as well as policies, as shown in FIG. 5. The context-aware policy model in FIG. 5 relates context to policy (PolicyConcept 564 is the base class of the DEN-ng Policy model) to the functionality of a system. The SelectsPolicies aggregation 566 defines a given set of Policies 124 that should be loaded based on the current context. Hence, as context changes, policy can change accordingly, enabling the network manager 112 to dynamically adapt the services and/or resources offered by the network to changing demands.

The PolicyResultAffectsContext association 568 enables policy results to influence Context. For example, if a policy execution fails, not only did the desired state change not occur, but the context may have changed as well as a result of a potentially incorrect action being executed or because a needed action was not executed in time. The selected working set of Policies 124 uses the GovernsManagedEntityRoles aggregation 570 to define the appropriate roles of the ManagedEntities 528 that are influenced by this Context; each ManagedEntityRole 572 defines functionality of the ManagedEntity 528 that can take on that role. In this way, policy indirectly (through the use of roles) controls the functionality of the system, again as a function of context. Both ManagedEntityRoles 572 and ManagementInfo 574 (management data describing the state of the ManagedEntity 528) are then linked to both Policy and Context by the four aggregations shown (GovernsManagementInfo 576, GovernsManagedEntityRoles 570, GovernsCapabilities 578, and SelectsPolicies 566).

Specifically, Policy is used to define which management information will be collected and examined; this management information affects policy decisions, as well as selecting which policies 124 should be used at any given time. Once the management information is defined, then the two associations MgmtInfoAltersContext 580 and ContextDependsOnMgmtInfo 582 codify these dependencies (e.g., context defines the management information to monitor, and the values of these management data affect context, respectively). The same is true from the ManagedEntityRole 572 side, using the ManagedEntityRoleAffectsPolicy 584 and ManagedEntityRoleAltersContext associations 586.

Note that the PolicyConcept class 564 has a relationship with the Capability class 542. This enables policies 124 to invoke capabilities to use as part of the condition and/or action portion of an Event-Condition-Action (“ECA”) PolicyRule, and capabilities to in turn identify the roles that implement the capabilities. Note that other representations, as defined for example in the DEN-ng Policy Model, can be used in addition to the ECA representation, and that the ECA mechanism can be used in addition to or instead of the above mentioned relationships.

Once capabilities have been identified, they can be represented in a graph, similar to how U.S. patent application Ser. No. 11/618,125, filed on Dec. 29, 2006, entitled, “Method and apparatus to use graph-theoretic techniques to analyze and optimize policy deployment”, with Attorney Docket Number CML04644MNG, (hereinafter refereed to as “CML04644MNG”), which is hereby incorporated by reference in its entirety, uses graphs to analyze and optimize policy deployment. The idea is simple, but powerful: the network manager 112 constructs a graph to represent the capabilities that are to be used in a system, and use policies 124 as described in CML04644MNG to adjust the weight of edges connecting the capabilities that are desired to be used. This results in preferring one set of capabilities over another, as described in CML04644MNG. In addition, the method described in the U.S. patent application Ser. No. 11/740,977, filed on Apr. 27, 2007, entitled “Utilizing Graphs To Detect And Resolve Policy Conflicts In A Managed Entity” with Attorney Docket Number CML04846MNG, which is incorporated by reference in its entirety, can be used to detect conflicts between capabilities.

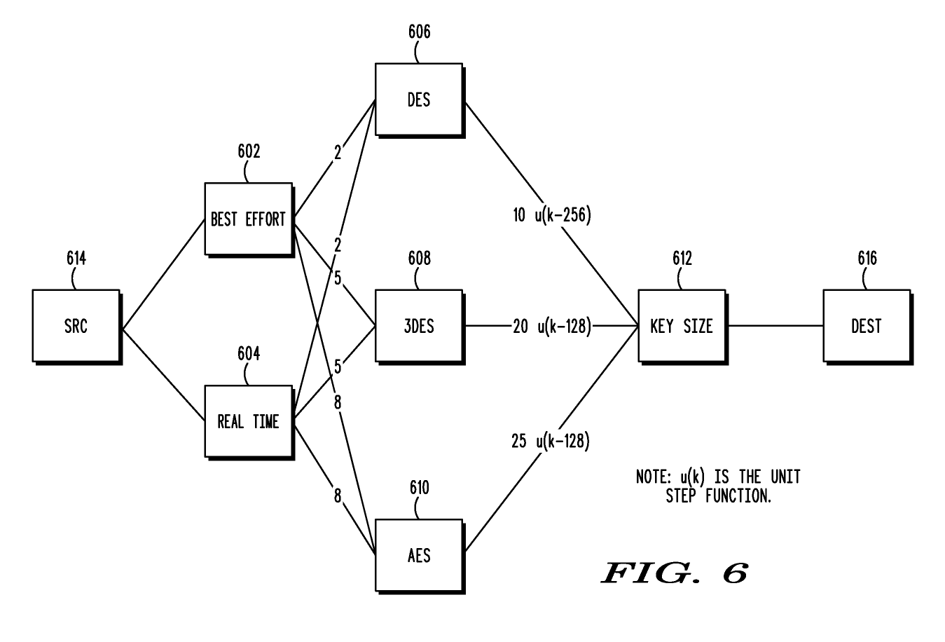

A summary of the policy based capability graph is shown in FIG. 6. In step 1, the capabilities are listed in columns and connected to form a basic graph. Capabilities with continuous values are listed as one node. In FIG. 6, the network manager 112 negotiates three functions that are each made up of different alternatives, represented as one or more different objects: service type (602, 604), security algorithm (606, 608, 610), and key size 612. Each object has several capabilities. In this example, the key size is actually a set of discrete value, such as 128, 256, 1024; for illustrative purposes, it is assumed to be of continuous value. Capabilities are connected from one object to the next and an artificial source 614 and destination node 616 are added.

In step 2, weights are assigned to links based on one or more policies. Edges connecting to a single node with continuous values are assigned formulas that can be dynamically calculated. For example, the policy 124 can add weights based on preference for certain capabilities of each object as a function of context. Furthermore, priority values can be added for each capability to be negotiated. For nodes with continuous values, the weight is a function to determine preference. With a graph with weights, the preference for a set of capabilities in a particular path is the sum of its weights. Note that there are many different paths that connect the source node 614 to the destination node 616; standard graph algorithms can then be used to find a path with the lowest total weight.

As previously stated, the current state-of-the-art is to write policies at a very low level, usually governing a small number of features. Since capabilities abstract a set of features, then this approach will produce an exponential explosion of policies that is not maintainable or usable. The various embodiments of the present invention use capabilities as a mechanism for aggregating similar features into a smaller number of atomic units. The capability model inherently gathers similar features together into a tree; this invention turns it into a graph, which can be more easily manipulated by a number of mechanisms. Hence, applying policies to these entities, which are at a higher level of abstraction, results in a significantly smaller number of total policies required to manage the functionality. Ontologies 122 augment the capabilities defined by an information model 120 by representing additional semantics that information models 120 cannot represent. Thus, they provide additional knowledge that the network manager 112 can use to build “better”, more functional, policies 124, as well as to help select which particular policies are applicable. Also, they enable higher level processes and algorithms to learn and reason about policies. Scalability is achieved by enabling each capability or set of capabilities to define its own set of roles; each role identifies its own functionality.

An optimal set of capabilities can be determined through any number of analytical means, such as the one described in CML04644MNG or by defining one or more appropriate utility functions to optimize one or more particular capabilities. Each utility function will output an overall preference score, given a set of capabilities as input. Each utility function is defined based on the capabilities, constraints, and active policies controlling said capabilities and constraints for each negotiator.

U.S. patent application Ser. No. ______ entitled “A Novel AAA System and Method for Dynamic Roaming Agreement of Heterogeneous Networks” by J. Fu, N. Jain, V. Ram, J. Strassner, S. Upadhyaya, M. Shin, Jul. 2, 2007, with Attorney Docket Number CML06081MNG, which is hereby incorporated by reference in its entirety, uses a novel negotiation process to determine the maximal benefit of using different capabilities offered by multiple providers, and to determine which set of capabilities provides the best benefit to all parties. Capabilities can also be discovered using machine learning. The capability construction and negotiation processes are observed, and used to re-examine the models 120 and ontologies 124. This is done to try and discover new capabilities that have not been discovered through the construction process. The network manager 112 can also learn how to use weights for different types of capabilities as a function of context and different negotiation scenarios.

Also, capabilities can be deduced using machine reasoning. Often, a class does not have all of its attributes and especially behavior modeled through discrete attributes, methods, and relationships. An abductive reasoning process can be used to reason from observed behavior which does not match capabilities back to the cause of such behavior, and hence deduce missing capabilities (i.e., determine that an existing class and/or ontological concept is lacking appropriate detail and missing one or more capabilities).

Additionally, capabilities can be used to guide policy continuum generation. Constructing a policy continuum, such as described in U.S. patent application Ser. No. 11/617,369, filed on Dec. 28, 2006, entitled “Creating and Managing a Policy Continuum” with Attorney Docket No. CML04553MNG which is hereby incorporated by reference in its entirety is complex. If capabilities can be defined at two adjacent continuum levels (e.g., a more precise description of a higher-level capability at a lower level of the continuum), then an additional test is to ensure that the resulting adjacent continuum levels define capabilities that support the same functionality and can be negotiated. If this is not the case, then the desired capabilities can be used to help guide the policy continuum generation process.

Operational Flow For Managing Network Elements Using Capabilities

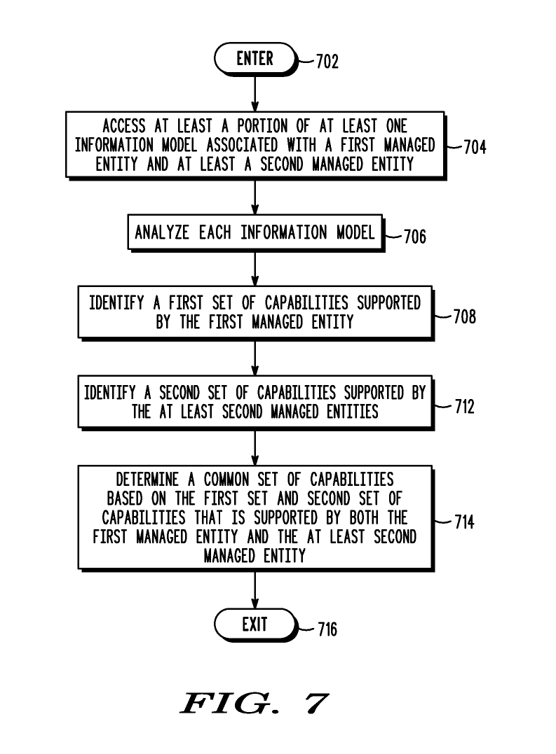

FIG. 7 is an operational flow diagram illustrating one process for managing network elements 104, 106, 108 based on capabilities. The operational flow begins at step 702 and flows directly to step 704. The network manager 112, at step 704, access at least a portion of an information model 120 associated with a first managed entity 104 and at least a second managed entity 106. The portion of the at least one information model 120 includes a set of capabilities associated with the first managed entity 104 and the at least second managed entity 106, respectively. The portion of the at least one information model 120 also represents at least one of characteristics and static behavior of each capability in the set of capabilities associated with the first and the at least second managed entity, respectively.

The network manager 112, at step 706, analyzes each information model 120. The network manager 120, at step 708, identifies a first set of capabilities that are supported by the first managed entity 104. The network manager 112, at step 710, identifies a second set of capabilities that are supported by the at least second managed entity 106. The network manager 112, at step 712, determines a set of common capabilities based on the first set and second set of capabilities that is supported by each of the first managed entity 104 and the at least second managed entity 106. The flow then exits at step 714.

Operational Flow For Constructing Capabilities

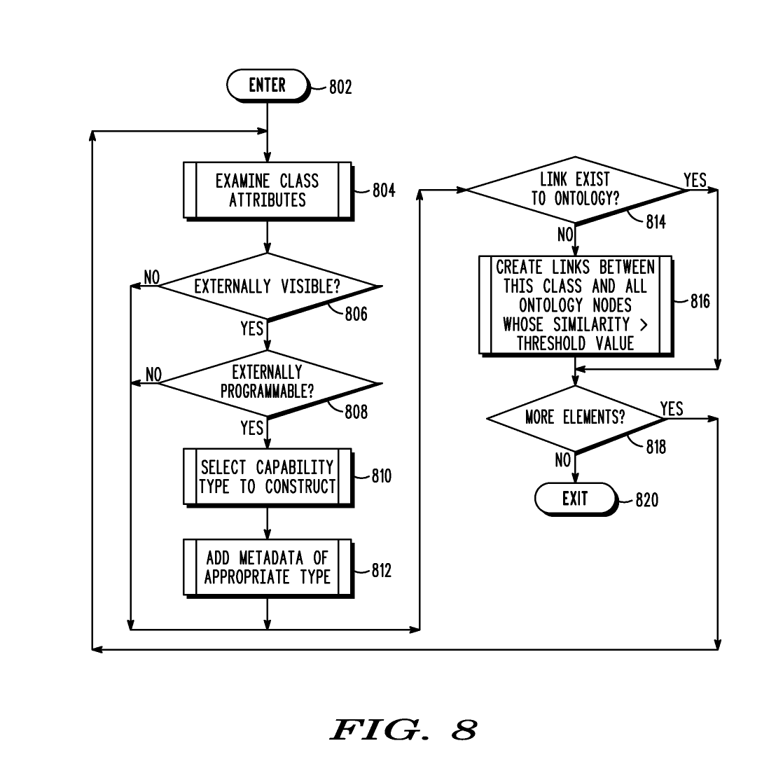

FIG. 8 is an operational flow diagram illustrating one process for constructing capabilities. The operational flow begins at step 802 and flows directly to step 804. It should be noted that in general, any attribute or relationship defined in a model 120 can be turned into a capability, as long as it is externally visible and programmable or can be monitored and/or controlled. The network manager 112 can construct capabilities in a model 120, an ontology 122, or in both a model 120 and an ontology 122. If an ontology is built, the network manager 112 builds a linguistic relationship such as synonyms associated with the managed entities.

The network manager 112, at step 804, examines each class attribute to determine if the class attribute is to be turned into a capability or not. In one embodiment, the network manager 112 can also examine a group of class attributes and construct a capability that represents one or more operations on those attributes. For example, the network manager 112, at step 806 determines whether the attribute is externally visible. If the result of this determination is negative, the control flows to step 814. If the result of this determination is positive, the network manager 112, at step 808 determines if the attribute is externally programmable. If the result of this determination is negative, the control flows to step 81 4. If the result of this determination is positive, the network manager 112, at step 810 selects a capability type (i.e., declarative, functional, or imperative) to construct.

The network manager 112, at step 812, then determines the specific metadata to add to the model 120 based on the capability type selected. The metadata is different for each capability type because the way in which a capability is used differs according to its type as well as the programming paradigm that will manipulate it. The network manager 112, at step 812, then adds the appropriate metadata to the model 120. The network manager 112, at step 814, determines if a link exists in the model 120 to a corresponding ontology 122. For example, an ontology 122 can include a similar capability to a capability in the model 120. Therefore, the network manager 112 determines if the model 120 and ontology 122 are linked so that ontology 122 can be used to analyze and/or reason about data in the model 120. In other words, a capability may be represented in both the model 120 as well as in one or more ontologies 122.

If the result of the determination at step 814 is negative, the network manager 112, at step 816, creates links between the model class currently being examined and all ontology nodes with a similarity greater than a given threshold. For example, the network manager 112 augments the metadata in the model 120 with extra fields to alert processes that use capabilities, since otherwise, extra work has to be done to construct a complex graph relating the model to the ontologies that augment it.

The control then flows to step 818. If the result of the determination at step 814 is positive, the network manager 112, at step 818, determines if more elements exist to be examined. If the result of this determination is positive, the control returns to step 804. If the result of this determination is negative, the control flow then exits at step 820.

Computing System

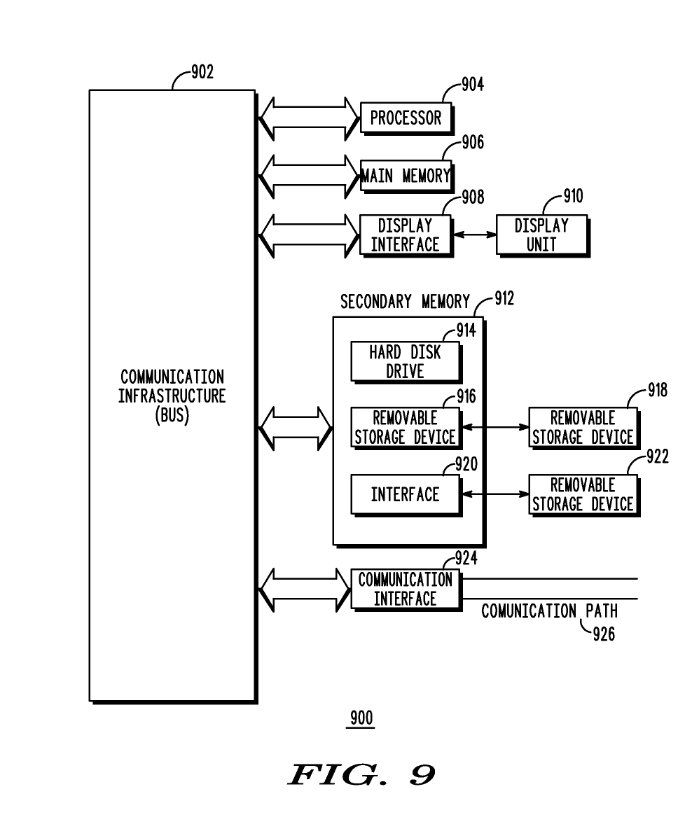

FIG. 9 is a high level block diagram illustrating a more detailed view of a computing system 900 such as the information processing system 102 useful for implementing the network manager 112 according to embodiments of the present invention. The computing system 900 is based upon a suitably configured processing system adapted to implement an exemplary embodiment of the present invention. For example, a personal computer, workstation, or the like, may be used.

In one embodiment of the present invention, the computing system 900 includes one or more processors, such as processor 904. The processor 904 is connected to a communication infrastructure 902 (e.g., a communications bus, crossover bar, or network). Various software embodiments are described in terms of this exemplary computer system. After reading this description, it becomes apparent to a person of ordinary skill in the relevant art(s) how to implement the invention using other computer systems and/or computer architectures.

The computing system 900 can include a display interface 908 that forwards graphics, text, and other data from the communication infrastructure 902 (or from a frame buffer) for display on the display unit 910. The computing system 900 also includes a main memory 906, preferably random access memory (RAM), and may also include a secondary memory 912 as well as various caches and auxiliary memory as are normally found in computer systems. The secondary memory 912 may include, for example, a hard disk drive 914 and/or a removable storage drive 916, representing a floppy disk drive, a magnetic tape drive, an optical disk drive, and the like. The removable storage drive 916 reads from and/or writes to a removable storage unit 918 in a manner well known to those having ordinary skill in the art.

Removable storage unit 918, represents a floppy disk, a compact disc, magnetic tape, optical disk, etc. which is read by and written to by removable storage drive 916. As are appreciated, the removable storage unit 918 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer-readable information.

In alternative embodiments, the secondary memory 912 may include other similar means for allowing computer programs or other instructions to be loaded into the computing system 900. Such means may include, for example, a removable storage unit 922 and an interface 920. Examples of such may include a program cartridge and cartridge interface (such as that found in video game devices), a removable memory chip (such as an EPROM, or PROM) and associated socket, and other removable storage units 922 and interfaces 920 which allow software and data to be transferred from the removable storage unit 922 to the computing system 900.

The computing system 900, in this example, includes a communications interface 924 that acts as an input and output and allows software and data to be transferred between the computing system 900 and external devices or access points via a communications path 926. Examples of communications interface 924 may include a modem, a network interface (such as an Ethernet card), a communications port, a PCMCIA slot and card, etc. Software and data transferred via communications interface 929 are in the form of signals which may be, for example, electronic, electromagnetic, optical, or other signals capable of being received by communications interface 924. The signals are provided to communications interface 924 via a communications path (i.e., channel) 926. The channel 926 carries signals and may be implemented using wire or cable, fiber optics, a phone line, a cellular phone link, an RF link, and/or other communications channels.

In this document, the terms “computer program medium,” “computer usable medium,” “computer readable medium”, “computer readable storage product”, and “computer program storage product” are used to generally refer to media such as main memory 906 and secondary memory 912, removable storage drive 916, and a hard disk installed in hard disk drive 914. The computer program products are means for providing software to the computer system. The computer readable medium allows the computer system to read data, instructions, messages or message packets, and other computer readable information from the computer readable medium.

Computer programs (also called computer control logic) are stored in main memory 906 and/or secondary memory 912. Computer programs may also be received via communications interface 924. Such computer programs, when executed, enable the computer system to perform the features of the various embodiments of the present invention as discussed herein. In particular, the computer programs, when executed, enable the processor 904 to perform the features of the computer system.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for managing entities, the method comprising:
accessing at least a portion of at least one information model for a first managed entity and at least a second managed entity, wherein the portion of the at least one information model includes a set of capabilities associated with the first managed entity and the at least second managed entity, respectively, wherein a capability is at least one of i) a feature; ii) a resource; or iii) a service associated with a managed entity and is externally visible by a given entity for external monitoring by the given entity and wherein each information model represents at least one of characteristics and static behavior of each capability in the set of capabilities;
identifying, based on the portion of the at least one information model, a first set of capabilities supported by the first managed entity and a second set of capabilities supported by the at least second managed entity; and
determining, in response to identifying the first set of capabilities and the second set of capabilities, a set of common capabilities from the first set of capabilities and the second set of capabilities that is supported by both of the first managed entity and the at least second managed entity.

2. The method of claim 1, further comprising:
augmenting the portion of the at least one information model with metadata associated with at least one capability in the set of capabilities associated with at least one of the first managed entity and the at least second managed entity, wherein the metadata describes data and concepts that aid in human and/or machine-based understanding of the capability associated with each of the at least one of the first managed entity and the at least one of the second managed entity.

3. The method of claim 2, wherein the metadata is determined based on a capability type associated with the at least one capability, wherein a capability type is one of:
a declarative capability,
a functional capability, and
an imperative capability

4. The method of claim 2, wherein the metadata is a role that indicates a function of the at least one capability.

5. The method of claim 1, further comprising:
building at least one ontology associated with at least one of the first managed entity and the second managed entity, wherein the at least one ontology specifies semantics associated with at least one capability in the set of capabilities associated with one of the first managed entity and the second managed entity.

6. The method of claim 5, further comprising:
augmenting at least one capability in the set of capabilities within the portion of at the least one first information model that is substantially similar to the at least one capability associated with the semantics specified in the at least one ontology.

7. The method of claim 6, further comprising:
building a linguistic relationship associated with the first managed entity and the at least second managed entity based on the at least one ontology; and
determining that at least one capability in associated with the first managed entity is semantically similar to at least one capability associated with the at least second managed entity.

8. The method of claim 6, further comprising:
building a linguistic relationship associated with the first managed entity and the at least second managed entity based on the at least one ontology; and
determining that at least one capability in associated with the first managed entity fails to be semantically similar to at least one capability associated with the at least second managed entity.

9. The method of claim 6, further comprising:
dynamically constructing at least one additional capability in the portion of at the least one first information model based at least in part on the semantic information associated with the at least one capability; and
storing the semantic information as metadata and/or links to one or more ontologies.

10. The method of claim 5, further comprising:
associating the at least one capability associated with the semantics specified by the ontology with at least one capability in the set of capabilities included in the portion of at the least one first information model.

11. The method of claim 10, wherein the associating further comprises:
adding at least one additional field in metadata associated with the at least one capability in the set of capabilities included in the portion of at the least one first information model that has been associated with the at least one capability associated with the semantics specified by the ontology, wherein the metadata indicates that the at least one ontology is associated with the at least one capability included in the portion of at the least one first information model.

12. The method of claim 1, further comprising:
selecting a set of policies for managing the first managed entity and the at least second managed entity; and
selecting a set of capabilities from the set of common capabilities based on the set of policies that have been selected.

13. The method of claim 12, wherein selecting a set of policies further comprises:
selecting the set of policies based on a context associated with each of the first managed entity and the at least second managed entity, respectively.

14. An information processing system for managing entities, the system comprising:
a memory;
a processor communicatively coupled to the memory; and
a network element manager communicatively coupled to the memory and the processor, wherein the network element manager is adapted to:
access at least a portion of at least one information model for a first managed entity and at least a second managed entity, wherein the portion of the at least one information model includes a set of capabilities associated with the first managed entity and the at least second managed entity, respectively, wherein a capability is at least one of i) a feature; ii) a resource;
or iii) a service associated with a managed entity and is externally visible by a given entity for external monitoring by the given entity and wherein the portion of the at least one information model represents at least one of characteristics and static behavior of each capability in the set of capabilities;
identify, based on the portion of the at least one information model, a first set of capabilities supported by the first managed entity and a second set of capabilities supported by the at least second managed entity; and
determine, in response to identifying the first set of capabilities and the second set of capabilities, a set of common capabilities from the first set of capabilities and the second set of capabilities that is supported by both of the first managed entity and the at least second managed entity.

15. The information processing system according to claim 14, wherein the network element manager is further adapted to:
augment the portion of the at least one information model with metadata associated with at least one capability in the set of capabilities associated with at least one of the first managed entity and the at least second managed entity, wherein the metadata describes data and concepts that aid in human and/or machine-based understanding of the capability associated with each of the at least one of the first managed entity and the at least one of the second managed entity.

16. The information processing system of claim 14, wherein the network element manager is further adapted to:
build at least one ontology associated with at least one of the first managed entity and the second managed entity, wherein the at least one ontology specifies semantics associated with at least one capability in the set of capabilities associated with one of the first managed entity and the second managed entity;
augment at least one capability in the set of capabilities within the portion of at the least one first information model that is substantially similar to the at least one capability associated with the semantics specified in the at least one ontology;
build a linguistic relationship associated with the first managed entity and the at least second managed entity based on the at least one ontology; and
determine at least one of
that at least one capability in associated with the first managed entity is semantically similar to at least one capability associated with the at least second managed entity; and
that at least one capability in associated with the first managed entity fails to be semantically similar to at least one capability associated with the at least second managed entity.

17. The information processing system of claim 14, wherein the network element manager is further adapted to:
select a set of policies for managing the first managed entity and the at least second managed entity; and
select a set of capabilities from the set of common capabilities based on the set of policies that have been selected.

18. A system for managing entities, the system comprising:
at least one network;
at least a first managed entity communicatively coupled to the network;
at least a second managed entity communicatively coupled to the network; and
at least one information processing system communicatively coupled to the network and the first managed entity and the at least second managed entity, wherein the information processing system includes;
a memory;
a processor communicatively coupled to the memory; and
a network element manager communicatively coupled to the memory and the processor, wherein the network element manager is adapted to:
access at least a portion of at least one information model for a first managed entity and at least a second managed entity, wherein the portion of the at least one information model includes a set of capabilities associated with the first managed entity and the at least second managed entity, respectively, wherein a capability is at least one of i) a feature; ii) a resource; or iii) a service associated with a managed entity and is externally visible by a given entity for external monitoring by the given entity and wherein the portion of the at least one information model represents at least one of characteristics and static behavior of each capability in the set of capabilities;
identify, based on the portion of the at least one information model, a first set of capabilities supported by the first managed entity and a second set of capabilities supported by the at least second managed entity; and
determine, in response to identifying the first set of capabilities and the second set of capabilities, a set of common capabilities from the first set of capabilities and the second set of capabilities that is supported by both of the first managed entity and the at least second managed entity.

19. The system of claim 18, wherein the network element manager is further adapted to:
build at least one ontology associated with at least one of the first managed entity and the second managed entity, wherein the at least one ontology specifies semantics associated with at least one capability in the set of capabilities associated with one of the first managed entity and the second managed entity;
augment at least one capability in the set of capabilities within the portion of at the least one first information model that is substantially similar to the at least one capability associated with the semantics specified in the at least one ontology;
build a linguistic relationship associated with the first managed entity and the at least second managed entity based on the at least one ontology; and
determine at least one of
that at least one capability in associated with the first managed entity is semantically similar to at least one capability associated with the at least second managed entity; and
that at least one capability in associated with the first managed entity fails to be semantically similar to at least one capability associated with the at least second managed entity.

20. The system of claim 18, wherein the network element manager is further adapted to:
select a set of policies for managing the first managed entity and the at least second managed entity; and
select a set of capabilities from the set of common capabilities based on the set of policies that have been selected.
